(19) United States
(12) Patent Application Publication
(10) Pub. No.: US 2025/0264853 A1
(43) Pub. Date: Aug. 21, 2025

(54) SETTING SUPPORT APPARATUS, PLC SYSTEM, AND PROGRAM PRODUCTS

(71) Applicant: Keyence Corporation, Osaka (JP)

(72) Inventor: Masato FUJIMURA, Osaka (JP)

(73) Assignee: Keyence Corporation, Osaka (JP)

(21) Appl. No.: 19/023,519

(22) Filed: Jan. 16, 2025

(30) Foreign Application Priority Data
Feb. 21, 2024 (JP) 2024-024318

(51) Int. Cl. G05B 19/05

(52) U.S. Cl. CPC G05B 19/054; G05B 19/056; G05B 2219/13144

(57) ABSTRACT

A burden on a user regarding a trial operation or tuning when a plurality of motor drivers whose manufacturers are different from each other are connected to a PLC is mitigated. Regarding motor control of each of a plurality of motor driving apparatuses, a storage unit stores setting information associated with a combination of vendor specifying information and product specifying information. A setting support apparatus selects any motor driving apparatus from among the plurality of motor driving apparatuses specified by pieces of the vendor specifying information and pieces of the product specifying information, respectively, reads setting information corresponding to a combination of the vendor specifying information and the product specifying information associated with the selected motor driving apparatus from the storage unit, generates an interface screen for a trial operation or tuning of the motor driving apparatus based on the setting information.

### CROSS-REFERENCE TO RELATED APPLICATIONS

The present application claims foreign priority based on Japanese Patent Application No. 2024-024318, filed Feb. 21, 2024, the contents of which are incorporated herein by reference.

### BACKGROUND OF THE INVENTION

### 1. TECHNICAL FIELD

The invention relates to a setting support apparatus, a PLC system, and a program.

### 2. DESCRIPTION OF THE RELATED ART

In factory automation, a programmable logic controller (PLC) is a core controller that controls industrial machines. Most of the industrial machines drive various loads using a motor as a drive source.

The PLC communicates with a motor driving apparatus (hereinafter, referred to as a motor driver) to drive a motor connected to the motor driver as described in JP 2015-012025 A.

In general, it is recommended that a manufacturer (vendor) of the PLC and a manufacturer of the motor driver coincide, but there is a case where a user owns a motor driver manufactured by another manufacturer, and desires to connect the motor driver to the PLC. In this case, the PLC and the plurality of motor drivers manufactured by mutually different manufacturers are used together. In order to perform a trial operation and tuning on the plurality of motor drivers whose manufacturers are different from each other as described above, it is necessary to connect dedicated setting support apparatuses for the manufacturers to the motor drivers, respectively. It would be convenient for the user if a trial operation or tuning can be performed on the plurality of motor drivers whose manufacturers are different from each other via a common user interface using a common setting support apparatus.

### SUMMARY OF THE INVENTION

Therefore, an object of the invention is to mitigate a burden on a user regarding a trial operation or tuning when a plurality of motor drivers whose manufacturers are different from each other are connected to a PLC.

For example, the invention provides a setting support apparatus that supports setting of a PLC system including
a programmable logic controller that functions as a main part of industrial communication and
a motor driving apparatus that functions as a peripheral of the industrial communication and drives a motor based on motor control data transmitted from the main part by the industrial communication, the setting support apparatus including:
a selection unit that selects any motor driving apparatus from among a plurality of the motor driving apparatuses specified by pieces of vendor specifying information and pieces of product specifying information, respectively, as the peripheral to be connected to the programmable logic controller functioning as the main part;
a storage unit that stores setting information related to motor control of each of the plurality of motor driving apparatuses, the setting information being associated with a combination of the vendor specifying information and the product specifying information;
a screen generation unit that reads, from the storage unit, the setting information corresponding to a combination of the vendor specifying information and the product specifying information associated with the motor driving apparatus selected by the selection unit, and generates an interface screen for a trial operation or tuning of the motor driving apparatus based on the setting information; and
a transmission unit that transmits an instruction received through the interface screen generated by the screen generation unit to the motor driving apparatus via the programmable logic controller and the industrial communication.

According to the invention, the burden on the user regarding the trial operation or the tuning when the plurality of motor drivers whose manufacturers are different from each other are connected to the PLC is mitigated.

### BRIEF DESCRIPTION OF THE DRAWINGS

FIG. 1 is a diagram illustrating a PLC system;

FIG. 2 is a diagram illustrating a setting support apparatus;

FIG. 3 is a diagram illustrating a basic unit;

FIG. 4 is a diagram illustrating a motor driver;

FIG. 5 is a diagram illustrating functions of a CPU;

FIG. 6 is a view illustrating a parameter setting screen;

FIG. 7 is a view illustrating a tuning screen;

FIG. 8 is a view illustrating a real-time chart monitor screen;

FIG. 9 is a view illustrating a trial operation screen;

FIG. 10 is a view illustrating a program;

FIG. 11 is a view illustrating a trial operation screen; and

FIG. 12 is a flowchart illustrating a setting method.

### DETAILED DESCRIPTION

Hereinafter, an embodiment will be described in detail with reference to the accompanying drawings. Note that the following embodiment does not limit the invention according to the claims, and all combinations of characteristics described in the embodiment are not necessarily essential for the invention. Two or more characteristics of a plurality of characteristics described in the embodiment may be arbitrarily combined. Further, the same or similar configurations are denoted by the same reference numerals, and redundant description will be omitted.

### PLC System

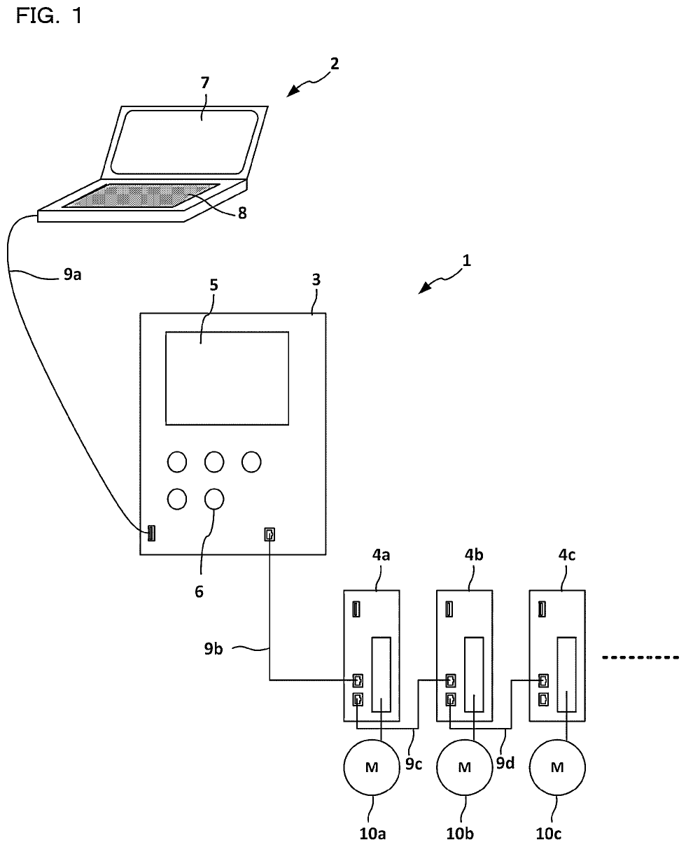

FIG. 1 illustrates a configuration example of a programmable logic controller system (hereinafter, referred to as a PLC system 1) according to the embodiment of the invention. As illustrated in FIG. 1, the PLC system 1 includes: a PC that is a setting support apparatus configured to edit a user program such as a ladder program; a basic unit 3 that is a programmable logic controller (PLC) configured for integrated control of various control apparatuses installed in a factory or the like; and a plurality of motor drivers 4a to 4c. The plurality of motor drivers 4a to 4c drive motors 10a, 10b, and 10c, respectively.

The user program created by the PC 2, which is the setting support apparatus, may be created using a graphical programming language such as a ladder language or a flowchart-format motion program, or may be created using a high-level programming language such as C language.

In the PLC system 1, one or a plurality of expansion units (for example, an I/O unit, an analog input unit, and an analog output unit) are connected to the basic unit 3. The basic unit 3 is sometimes also referred to as a CPU unit or a main unit. The motor drivers 4a to 4c may be referred to as slave equipment or peripherals.

The basic unit 3 includes a display unit 5 and an operation unit 6. The display unit 5 can display operation statuses of the motor drivers 4a to 4c. The display unit 5 may switch display content according to operation content of the operation unit 6. The display unit 5 normally displays a current value (device value) of a device in the PLC system 1, information on an error (presence or absence of an alarm or warning) occurring in the PLC system 1, and the like. The device is a name indicating an area on a memory provided to store a device value (device data), and may be referred to as a device memory. The device value is information indicating an input state from input equipment, an output state to output equipment, or a state of an internal relay (auxiliary relay), a timer, a counter, a data memory, or the like set on the user program. Types of the device value include a bit type and a word type. A bit device stores a 1-bit device value. A word device stores a device value of one word.

The motor drivers 4a to 4c are prepared to extend functions of the PLC system 1. The motors 10a to 10c are controlled by the motor drivers 4a to 4c, respectively. The motor drivers 4a to 4c supply electric power to the motors 10a to 10c, and control a rotation amount and the like according to a command from the basic unit 3. Examples of the motors 10a to 10c include a servo motor and a stepping motor.

The PC 2 is a computer that provides a development environment of the PLC system 1. The PC 2 is, for example, a portable notebook type or tablet type personal computer, and includes a display unit 7 and an operation unit 8. The ladder program, which is an example of the user program configured to control the PLC system 1, is created using the PC 2. The created ladder program is converted into a mnemonic code in the PC 2. The PC 2 is connected to the basic unit 3 of the PLC system 1 via a communication cable 9a such as a universal serial bus (USB), and sends the ladder program converted into the mnemonic code to the basic unit 3. The basic unit 3 converts the ladder program into a machine code and stores the machine code in a memory provided in the basic unit 3. Note that the mnemonic code is transmitted to the basic unit 3 here, the invention is not limited thereto. For example, the PC 2 may convert the mnemonic code into an intermediate code, and send the intermediate code to the basic unit 3.

Note that the operation unit 8 of the PC 2 may include a pointing device such as a mouse connected to the PC 2 although not illustrated in FIG. 1. Further, the PC 2 may be configured to be detachably connected to the basic unit 3 via another communication cable 9a other than the USB. Further, the PC 2 may be wirelessly connected to the basic unit 3 without using the communication cable 9a. In this case, the communication cable 9a may be understood to represent a wireless link.

The basic unit 3 and the motor driver 4a are connected by a communication cable 9b, and can perform communication (for example, cyclic communication and message communication) with each other via the communication cable 9b. The motor driver 4a and the motor driver 4b are connected by a communication cable 9c, and can communicate with each other via the communication cable 9c. The motor driver 4b can communicate with the basic unit 3 via the communication cables 9b and 9c. The motor driver 4b and the motor driver 4c are connected by a communication cable 9d, and can communicate with each other via the communication cable 9d. Further, the motor driver 4c can communicate with the basic unit 3 via the communication cables 9b, 9c, and 9d.

Although the motor drivers 4a to 4b are connected in this example, the number of motor drivers 4 may be one or more. Manufacturers of the motor drivers 4a to 4c may be different from each other or the same. Here, it is assumed that the motor drivers 4a to 4c are manufactured by different manufacturers, respectively, for convenience of description.

Hereinafter, the motor drivers 4a to 4c are expressed as motor drivers 4 when common matters are described. Similarly, the motors 10a to 10c are expressed as motors 10 when common matters are described.

### Setting Support Apparatus

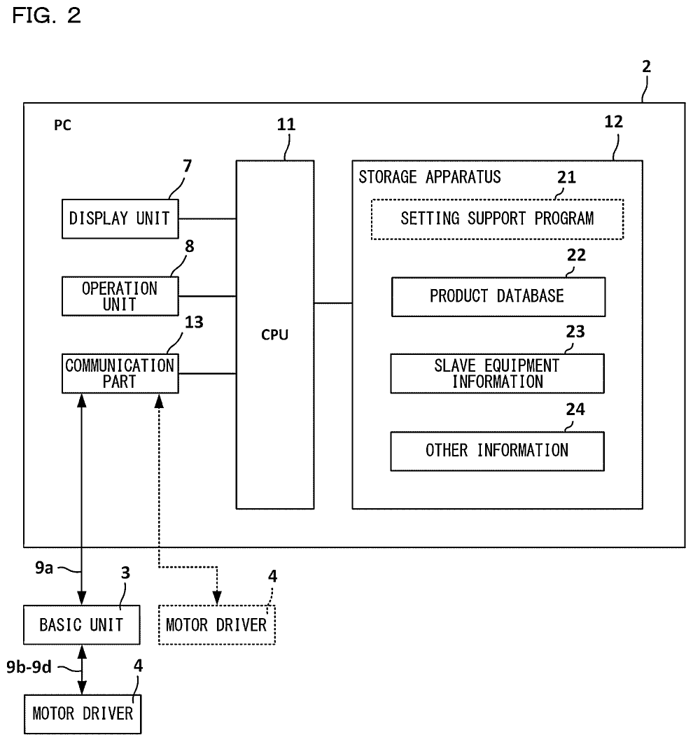

FIG. 2 is a block diagram illustrating an electrical configuration of the PC 2. As illustrated in FIG. 2, the PC 2 includes a CPU 11, the display unit 7, the operation unit 8, a storage apparatus 12, and a communication part 13. The display unit 7, the operation unit 8, the storage apparatus 12, and the communication part 13 are electrically connected to the CPU 11. The storage apparatus 12 includes a RAM, a ROM, an HDD, and an SSD, and may further include a detachable memory card. The CPU is an abbreviation for central processing unit. The ROM is an abbreviation for read-only memory. The RAM is an abbreviation for random access memory. The HDD is an abbreviation for hard disk drive. The SSD is an abbreviation of solid state drive.

A user of the PC 2 causes the CPU 11 to execute a setting support program 21 stored in the storage apparatus 12 to edit project data through the operation unit 8, to execute setting of each of the motor drivers 4, and to acquire alarm information from each of the motor drivers 4 and display the alarm information on the display unit 7. The PC 2 may also be referred to as an engineering tool. The project data includes one or more user programs (for example, ladder programs) and configuration information of the basic unit 3, the motor drivers 4, and the motors 10. The configuration information is information indicating connection positions of the plurality of motor drivers 4 with the basic unit 3 and functions (for example, a communication function and a positioning function) provided in the basic unit 3, information indicating functions of the motor drivers 4, and device allocation information. Here, the editing of project data includes creating and changing (re-editing) of project data. The user reads the project data stored in the storage apparatus 12 as necessary, and changes the project data using the setting support program 21. The communication part 13 communicates with the basic unit 3 via a communication cable 9a. The CPU 11 transfers the project data to the basic unit 3 via the communication part 13. The communication part 13 includes a communication circuit capable of executing communication conforming to a USB standard, a communication circuit that performs wired LAN communication, a communication circuit that performs wireless LAN communication, and the like. The communication part 13 may communicate with the motor drivers 4 via a communication cable. The communication part 13 transmits, for example, a parameter read request or a read or write request, an alarm detail acquisition request, and the like to the basic unit 3. Note that a communication protocol between the PC 2 and the basic unit 3 may be a general-purpose protocol or a unique protocol. Meanwhile, a frame format includes information for the basic unit 3 to make various requests to the motor drivers 4 via Industrial Ethernet. Further, the communication part 13 can execute cyclic communication and message communication.

The basic unit 3 is referred to as master equipment. The motor driver 4 is an example of slave equipment. A product database 22 includes identification information (a vendor ID, a product code, a revision number) for identifying the slave equipment connected to the basic unit 3. The vendor ID is unique identification information (vendor specifying information) of a manufacturer (vendor) that manufactures the slave equipment. The product code is identification information (product specifying information or product identification information) that is unique to the vendor and is allocated to distinguish different pieces of slave equipment provided by the same vendor. The revision number is identification information allocated to distinguish the same revision of the slave equipment. The product database 22 may be input by the user through the operation unit 8, or may be acquired from the slave equipment by communicating with the slave equipment via the basic unit 3 and stored in the storage apparatus 12.

Further, the CPU 11 may store the product database 22 of the slave equipment in the storage apparatus 12 in association with a connection position of the slave equipment designated through the operation unit 8. This may be managed as configuration information (other information 24) that is a part of the project data.

Slave equipment information 23 includes various pieces of information related to the slave equipment (for example, the motor driver 4). The slave equipment information 23 may include slave equipment-specific information, parameter information, and alarm information. The slave equipment-specific information may include product specifying information (a vendor ID, a product code, and a revision number) registered in the product database 22, information indicating whether equipment that explicitly requires a write operation with respect to a non-volatile memory after parameter reflection, information indicating how to acquire an alarm detail code, and the like. The parameter information may include a parameter list, an option list, and an operation sequence list, and details of these will be described later. The alarm information may include an alarm list, and details thereof will be described later.

The parameter information (setting information) included in the slave equipment information 23 includes, for example, a parameter name, an object index/sub-index, a data type, a minimum value, a maximum value, and a display type (for example, enumeration type/Dec type), an enum name (for example, ENUM_TUNING), parameter type (mode/readable and writable parameter/read-only parameter), a control type (for example, a track bar, a numerical box, a drop-down list, or a button), and the like. An index and a sub-index are indexes designated on the slave equipment side when each parameter is written or read. That is, based on the index/sub-index, the slave equipment understands whether to write a value to the parameter or which parameter needs to be read and transmitted to the master equipment. The index normally exists in any communication protocol, but whether the sub-index exists depends on a protocol of Industrial Ethernet. The parameter information (setting information) may be used to provide a common user interface regardless of vendors and products. The slave equipment information 23 is associated with vendor specifying information and product specifying information, and can be specified by a combination of the vendor specifying information and the product specifying information.

The slave equipment information 23 may be provided as a part of the development environment (the setting support program 21). The slave equipment information 23 may be downloaded from a website of a vendor. The slave equipment information 23 may be provided through a recording medium that can be carried.

In this manner, the storage apparatus 12 functions as an assignment information storage unit that stores the slave equipment information 23 as assignment information in association with the slave equipment. The slave equipment (the motor driver 4) is specified based on the vendor ID, the product code, and the revision number (the product specifying information/product identification information). For the slave equipment, there are a plurality of setting parameters. Among the plurality of setting parameters, there are a plurality of adjustment-recommended parameters for which adjustment is recommended so as to operate the slave equipment to adapt to the master equipment (the basic unit 3). Thus, the slave equipment information 23 is information for assigning the product specifying information (product identification information) of the slave equipment and the plurality of adjustment-recommended parameters.

### Basic Unit (Master Equipment)

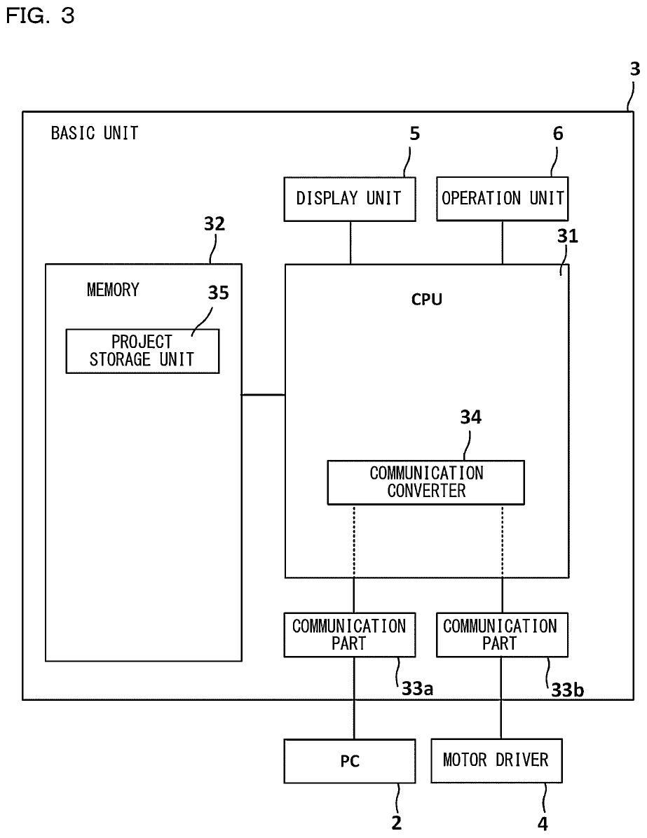

FIG. 3 illustrates a hardware configuration of the basic unit 3. The CPU 31 writes information in a memory 32 and reads information from the memory 32. The memory 32 includes a RAM, a ROM, an HDD, and an SSD, and may further include a detachable memory card. A project storage unit 35 is a ROM area that stores the project data created and transferred by the PC 2. The project data includes the user program, the configuration information, and the like. Furthermore, the CPU 31 receives an input of information from the operation unit 6. The CPU 31 displays various types of information on the display unit 5.

The CPU 31 is connected to the PC 2 via a communication part 33a, and is connected to the motor driver 4 via a communication part 33b to perform communication. The communication part 33a is, for example, a communication circuit compatible with a USB. The communication part 33b is a communication circuit capable of executing communication compatible with a protocol of Industrial Ethernet (for example, EtherCAT, EtherNet/IP, PROFINET, and MECHATROLINK-III). Further, the communication parts 33a and 33b can execute cyclic communication and message communication. A communication converter 34 is a function implemented by the CPU 31, and converts and relays a communication signal between the PC 2 and the motor driver 4. For example, the communication converter 34 converts a request from the PC 2 to the motor driver 4 so as to conform to the protocol of Industrial Ethernet, and transmits the request to the motor driver 4 as a proxy of the PC 2. The communication converter 34 converts a response from the motor driver 4 so as to conform to the communication protocol between the PC 2 and the basic unit 3, and transfers the response to the PC 2.

### Motor Driver (Slave Equipment)

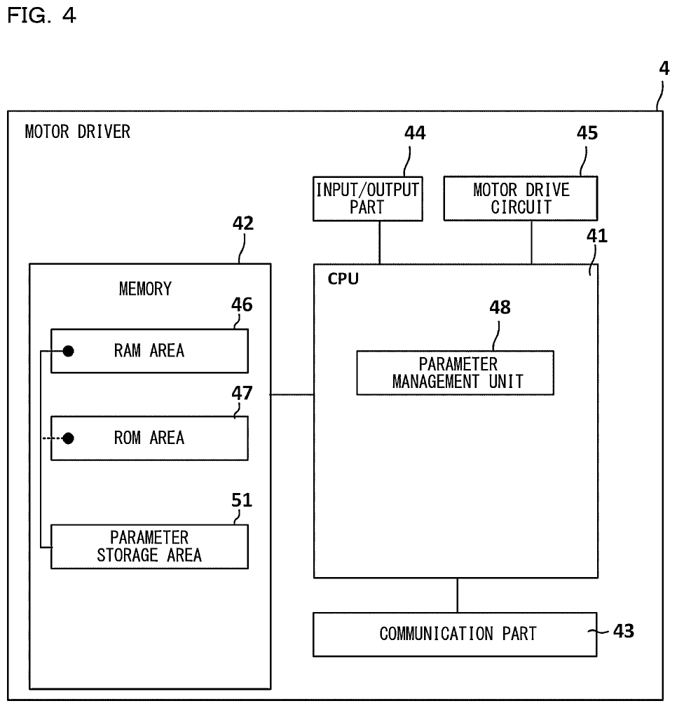

FIG. 4 illustrates a hardware configuration of the motor driver 4. The CPU 41 writes information in a memory 42 and reads information from the memory 42. The memory 42 includes a RAM, a ROM, an HDD, and an SSD, and may further include a detachable memory card. The memory 42 includes a RAM area 46 and a ROM area 47.

The CPU 41 communicates with the basic unit 3 and the other motor drivers 4 via a communication part 43. The communication part 43 is a communication circuit capable of executing communication compatible with a protocol of Industrial Ethernet (for example, EtherCAT, EtherNet/IP, PROFINET, and MECHATROLINK-III). The communication part 43 can execute cyclic communication and message communication. Motor control data is transmitted from the basic unit 3 by the cyclic communication.

An input/output part 44 includes an input terminal and an input circuit to which a limit switch or the like is connected, and an output circuit and an output terminal that output information to the outside. A motor drive circuit 45 supplies electric power for driving the motor 10 and a control signal to the motor 10. Note that the electric power to the motor 10 may be supplied from an external power supply.

The CPU 41 includes a parameter management unit 48. The parameter management unit 48 stores and manages various parameters necessary for control of the motor 10 in a parameter storage area 51. The parameter management unit 48 may be secured in any one or both of the RAM area 46 and the ROM area 47.

### Functions of CPU 11 in PC 2

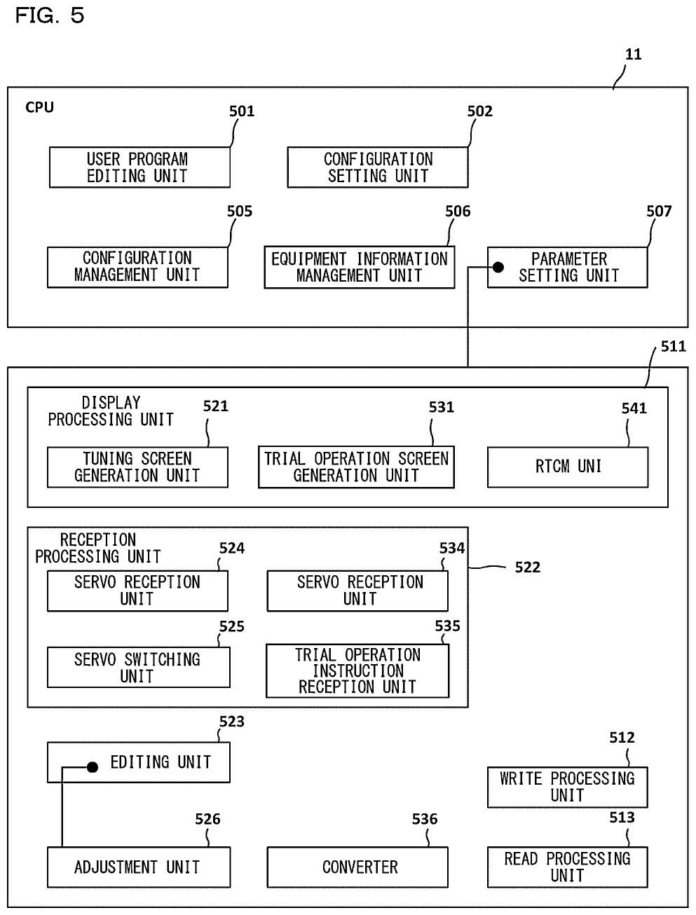

FIG. 5 illustrates functions implemented by the CPU 11 executing the setting support program 21.

A user program editing unit 501 displays a UI for editing a user program executed by the basic unit 3 on the display unit 7, receives editing of the user program through the UI, and creates the user program. A configuration setting unit 502 creates configuration information indicating product information, connection positions, and the like of the basic unit 3, the motor driver 4, and the motor 10 constituting the PLC system 1. For example, the configuration setting unit 502 displays a product list on the display unit 7, and drops a product selected from the product list on the UI to arrange the product at the dropped position. For example, an icon imitating the basic unit 3 is displayed on the UI, and configuration information indicating that the motor driver 4a is connected next to the basic unit 3 is created by dropping an icon of the motor driver 4a next to the icon of the basic unit 3. Further, configuration information indicating that the motor driver 4b is connected next to the motor driver 4a is created by dropping an icon of the motor driver 4b next to the icon of the motor driver 4a. In this manner, types of the master equipment and the plurality of pieces of slave equipment and connection positions are specified by the configuration setting unit 502 and managed by the configuration information. A configuration management unit 505 manages the product database 22. An equipment information management unit 506 manages the slave equipment information 23. A parameter setting unit 507 sets a plurality of parameters used to control the basic unit 3 and the motor driver 4.

The parameter setting unit 507 includes a display processing unit 511 in charge of display processing of a user interface (UI), a reception processing unit 522 that receives a user input through the UI, an editing unit 523 in charge of editing a parameter value, a write processing unit 512 that transfers and writes the edited parameter to slave equipment, a read processing unit 513 that reads a parameter from the slave equipment, a converter 536 that converts a set motion parameter into a program (for example, program written in mnemonics, structured text (ST) language), and the like.

The display processing unit 511 reads, from the storage apparatus 12, setting information (for example, the slave equipment information 23) corresponding to a combination of vendor specifying information and product specifying information associated with the motor driver 4 selected by the user, and generates an interface screen for a trial operation or tuning of the motor driver 4 based on the setting information. As a result, the interface screen has a substantially common appearance even if vendors of the motor drivers 4 are different. Similarly, the interface screen has a substantially common appearance even if the motor drivers 4 are manufactured by the same vendor and the motor drivers 4 are different products (models (high-level model, standard model, and low-level model)). For example, a tuning screen generation unit 521 reads, from the storage apparatus 12, setting information corresponding to a combination of vendor specifying information and product specifying information associated with the motor driver 4 selected by the user, and generates a tuning screen for tuning the motor driver 4 based on the setting information. The tuning screen may simultaneously display a plurality of axes such that the user can tune parameters thereof. A trial operation screen generation unit 531 reads, from the storage apparatus 12, setting information corresponding to a combination of vendor specifying information and product specifying information associated with the motor driver 4 selected by the user, and generates a trial operation screen for a trial operation of the motor driver 4 based on the setting information. An RTCM unit 541 reads, from the storage apparatus 12, setting information corresponding to a combination of vendor specifying information and product specifying information associated with the motor driver 4 selected by the user, and generates a display screen of a real-time chart monitor (RTCM) for the motor driver 4 based on the setting information. The real-time chart monitor is called from the tuning screen or the trial operation screen, and displays current coordinate, speed, feedback torque, on/off of positioning control, settling time, and the like. The settling time is a time until the motor 10 moves to a position (coordinate) instructed by a positioning instruction since the time when the motor driver 4 transmits a positioning instruction to the motor 10.

The reception processing unit 522 receives selection of one of the motor drivers 4 from among the plurality of motor drivers 4 specified by pieces of vendor specifying information and pieces of product specifying information, respectively. For example, the reception processing unit 522 includes a servo reception unit 524 that receives designation of a servo (the motor driver 4) serving as a tuning target, a servo reception unit 534 that receives designation of a servo (the motor driver 4) serving as a trial operation target, a servo switching unit 525 that receives a switching instruction of the servo (the motor driver 4) serving as the tuning target, a trial operation instruction reception unit 535 that receives an instruction on trial operations of a plurality of axes (the motors 10), and the like.

The editing unit 523 can read a current value of the parameter written in the slave equipment at that time through the read processing unit 513. An adjustment unit 526 generates an adjustment instruction according to a parameter adjustment instruction received through the reception processing unit 522, and transmits the adjustment instruction to the slave equipment to be adjusted through the write processing unit 512. In particular, the write processing unit 512 specifies a format of an instruction for the motor driver 4 based on the slave equipment information 23 corresponding to a combination of vendor specifying information and product specifying information associated with the motor driver 4 selected as an instruction target, embeds the instruction in the specified format (for example, an instruction name, a parameter name, an instruction value, an embedding position and the number of bits of each piece of data, and the like), and transmits the instruction. The read processing unit 513 reads a current value (for example, coordinate, speed, acceleration, deceleration, jerk, or the like) from the motor driver 4 selected by the user. For example, the read processing unit 513 specifies a format of a read instruction for the motor driver 4 based on the slave equipment information 23 corresponding to a combination of vendor specifying information and product specifying information associated with the motor driver 4 selected as a reading target, creates the read instruction according to the specified format, and transmits the instruction.

### Parameter Setting Screen

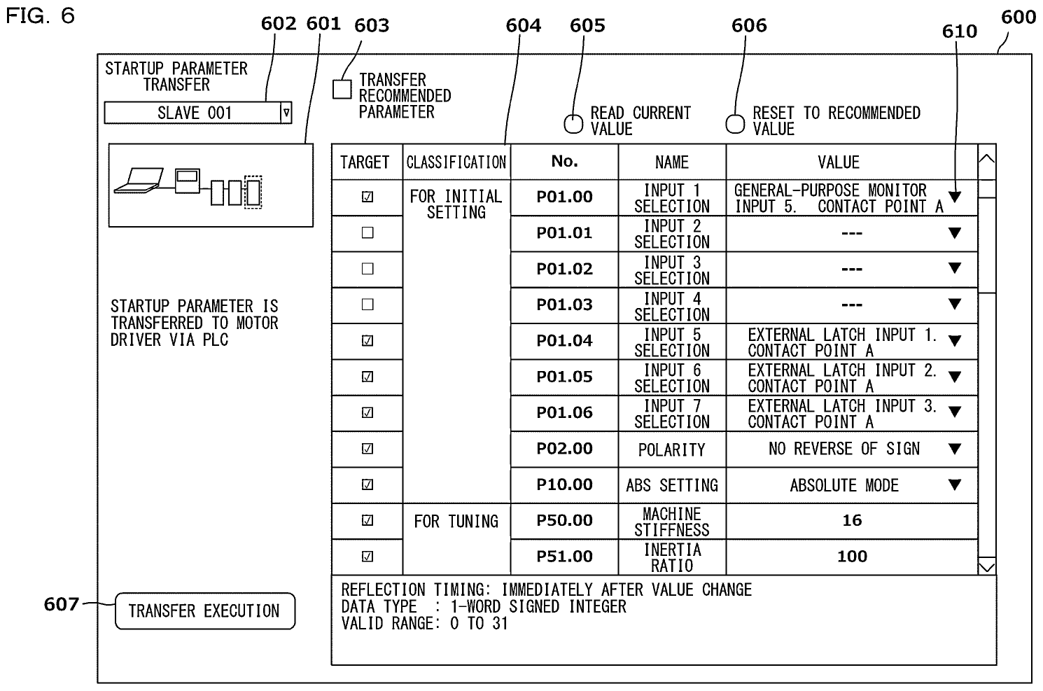

FIG. 6 illustrates a UI 600 displayed on the display unit 7 by the parameter setting unit 507. The UI 600 may be generated to have a substantially common appearance regardless of a vendor and a product type (model) of the motor driver 4. The UI 600 is a user interface configured to set and transfer a parameter necessary for startup of the PLC system 1. A configuration display part 601 shows a configuration of the PLC system 1 set through the configuration setting unit 502. An equipment selection part 602 displays a list (pull-down menu) for selecting setting target equipment, and receives selection of the equipment. When the equipment is selected through the equipment selection part 602, the configuration display part 601 highlights an icon of the selected equipment. In this example, the icon of the selected equipment is surrounded by a frame line on a broken line. A check box 603 is a button that is checked when a recommended parameter prepared in advance is transferred. A value setting part 604 is a UI configured to select a parameter to be transferred to the selected equipment and set a value of the parameter. Note that the pull-down menu may be referred to as a drop-down list or a combo box.

A current value read button 605 is a button for reading a value of a parameter set at that time for the selected equipment from the selected equipment through the PLC system 1 and reflecting the value in the value setting part 604. A recommended value reset button 606 is a button for overwriting the value set in the parameter with a recommended value. The recommended value of each parameter is stored in advance in the storage apparatus 12. For example, the recommended value may be a part of the slave equipment information 23.

A transfer execution button 607 is a button for instructing the equipment selected by the equipment selection part 602 to transfer the parameter selected by the value setting part 604. As a result, the parameter is written into the slave equipment.

Meanwhile, the parameter information includes the parameter list, the option list, and the operation sequence list. The parameter list is a list of parameters that can be set to transfer target slave equipment through the parameter setting screen (the UI 600). The number of the parameters that can be set to the slave equipment is several hundred in a case where the number is large. However, the number of parameters generally used by many users is about ten to several tens. Therefore, the parameter list is narrowed down to a parameter that needs to be set or a parameter that is generally used by many users. This reduces complexity of the parameter setting screen. The parameters included in the parameter list are, for example, as follows.
(a) Parameters that need to be set in advance in accordance with recommended settings on master equipment side (for example, input assignment and polarity)
(b) Parameters that are controlled by PLC system 1 and need to be set in accordance with mechanical configuration of user (load driven by motor 10) (for example, rotation direction of motor 10)
(c) Parameters that are controlled by PLC system 1 and need to be adjusted (tuned) in accordance with to mechanical configuration of user (load driven by motor 10) (for example, machine stiffness and inertia ratio)

Meanwhile, as a method for setting a value in the value setting part 604, for example, there are a method of directly inputting a value and a method of selecting a value from a pull-down menu 610. A display format of the value may be any of a binary number, a decimal number, and a hexadecimal number.

### Tuning Screen

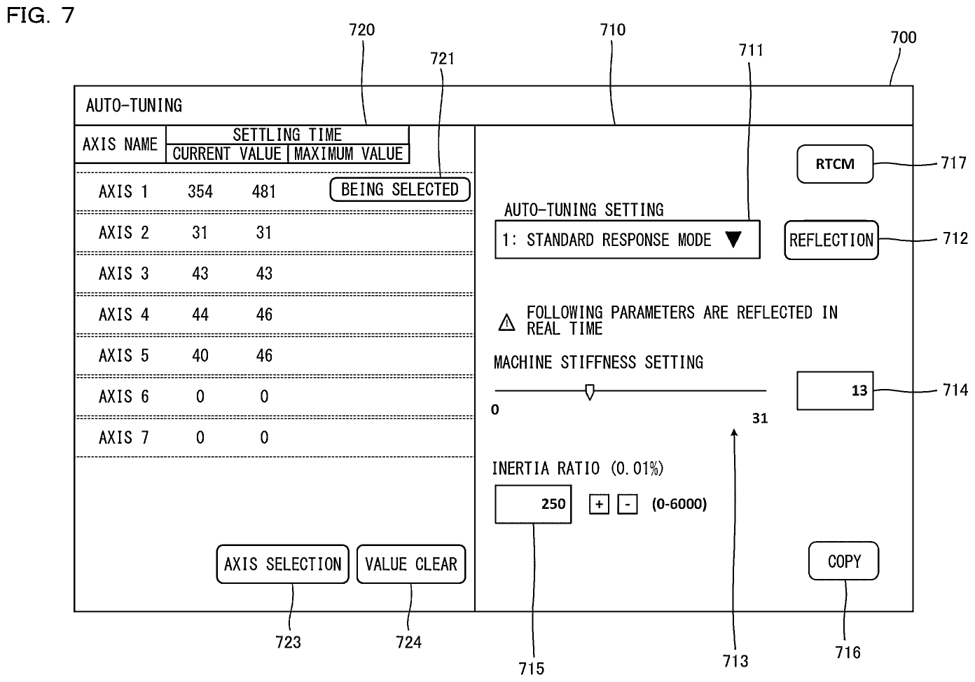

As illustrated in FIG. 7, a tuning screen 700 is a screen that receives an input of an instruction to automatically adjust a parameter for each of the motors 10 or each axis. The tuning screen 700 may also be generated so as to have a substantially common appearance regardless of a vendor and a product type (model) of the motor driver 4. However, when a parameter that can be set is different for each of the motor drivers 4, the tuning screen 700 corresponding to the parameter that can be set is generated. That is, a type of the parameter adjustably displayed on the tuning screen 700 and a control type (for example, a slide bar, a numerical box, or a drop-down list) for adjusting the parameter are stored in the slave equipment information 23.

An axis selection part 720 is a UI for selecting an axis serving as a target of auto-tuning among the axes included in the PLC system 1. In this example, two axes are selected in advance, and one axis set through an auto-tuning setting part 710 is selected by an axis selection button 723. Note that an indicator 721 indicating an axis being selected among a plurality of axes may be provided. The axis selection part 720 may have a display area for displaying a name of the axis, a current value and a maximum value of the settling time, and the like. A value clear button 724 is a button for clearing the current value and the maximum value of the settling time. Note that the current value of the settling time may be updated every time a positioning operation is performed once.

In the auto-tuning setting part 710, a mode selection part 711 is a pull-down menu for selecting any one of a plurality of auto-tuning modes. A reflection button 712 is a button for reflecting the auto-tuning mode selected by the mode selection part 711 in the slave equipment. That is, if the reflection button 712 is not pressed, the auto-tuning mode selected by the mode selection part 711 is not reflected in the slave equipment.

A machine stiffness setting part 713 is a slide bar for setting machine stiffness of a load connected to the slave equipment. A setting value display part 714 displays a setting value of the machine stiffness set by the machine stiffness setting part 713. Note that the machine stiffness is immediately set to the slave equipment.

An inertia ratio setting part 715 includes a plus button, a minus button, and a setting value display part which are configured to set an inertia ratio of the load of the slave equipment. The inertia ratio is also immediately reflected in the slave equipment.

A copy button 716 is a button for giving an instruction to copy settings of one axis to another axis. An RTCM button 717 is a button for giving an instruction to display the real-time chart monitor for the axis being selected.

### Real-Time Chart Monitor (RTCM)

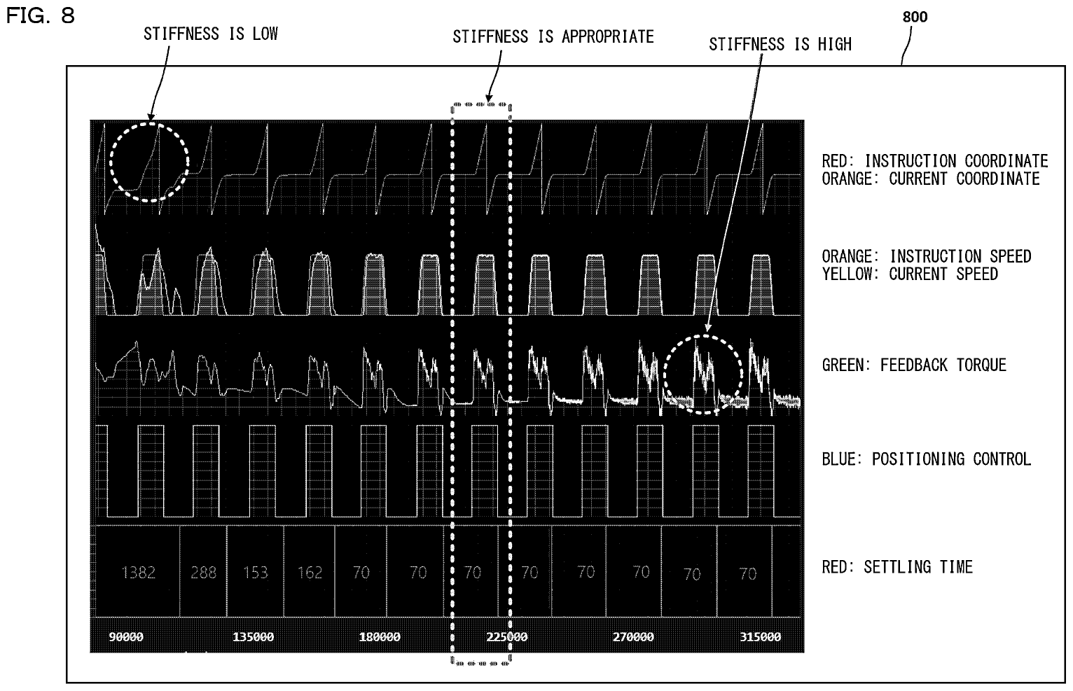

FIG. 8 illustrates an example of an RTCM screen 800. As an example, the stiffness is set to gradually increase by operating the slide bar of the machine stiffness setting part 713. The RTCM screen 800 may also be generated so as to have a substantially common appearance regardless of a vendor and a product type (model) of the motor driver 4.

The RTCM screen 800 displays various numerical values for the axis being selected on the tuning screen 700. A plurality of pre-associated numerical values among the various numerical values may be grouped and displayed in an overlapping manner on a graph.

In this example, an instruction coordinate, which is a coordinate instructed by the PC 2, and a current coordinate of the axis being selected are displayed in a comparable manner. In this example, it is illustrated that the current coordinate deviates from the instruction coordinate because the stiffness is low at a certain time. If the stiffness is appropriate, the instruction coordinate and the current coordinate overlap. The instruction coordinate and the current coordinate are displayed in different colors.

An instruction speed, which is a movement speed instructed by the PC 2, and a current speed, which is a current movement speed of the axis being selected, may be displayed in a comparable manner. Further, a feedback torque, an execution period/stop period of positioning control, a settling time, and the like may also be displayed. The instruction speed and the current speed are displayed in different colors.

When the stiffness is appropriately set by auto-tuning, the settling time is sufficiently short.

Note that the high stiffness appears in the feedback torque. The user can check whether the auto-tuning is successful by checking these numerical values or the graph through RTCM screen 800. Further, the user can check whether fine adjustment is successful by viewing the RTCM screen 800 while finely adjusting the parameter on the tuning screen 700.

### Trial Operation Screen

### (1) Trial Operation on Single Axis

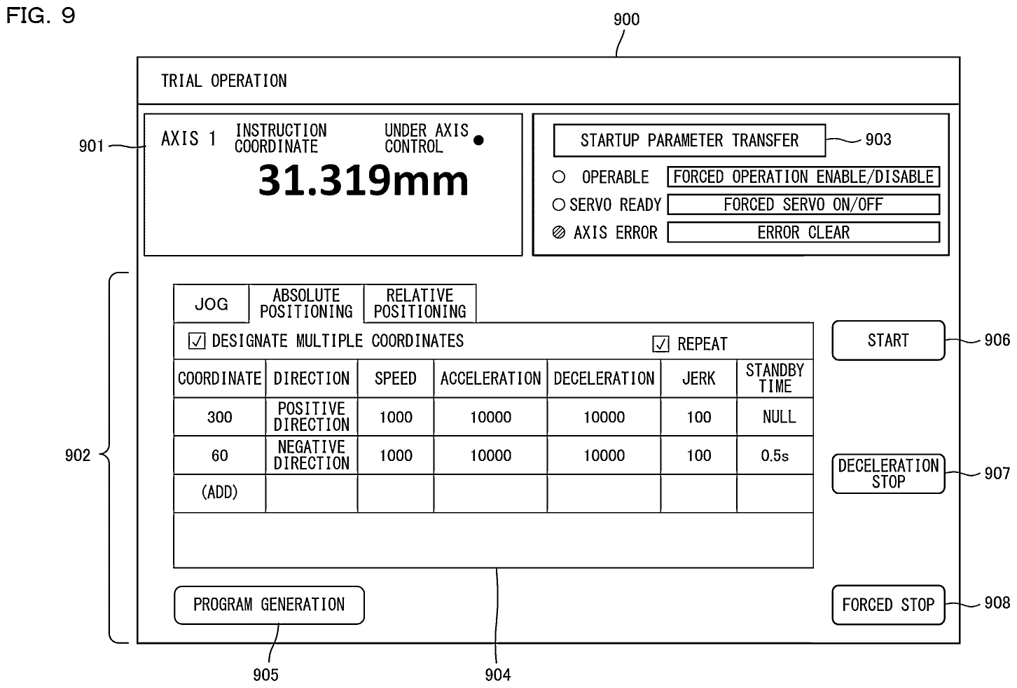

FIG. 9 illustrates a trial operation screen 900 in a case where a trial operation is executed on a single axis. The trial operation screen 900 may also be generated so as to have a substantially common appearance regardless of a vendor and a product type (model) of the motor driver 4. However, when a parameter that can be set is different for each of the motor drivers 4, the trial operation screen 900 corresponding to the parameter that can be set is generated. That is, a type (for example, a current coordinate or an instruction coordinate) of a parameter displayed on the trial operation screen 900 and a control type (for example, a button, a checkbox, or a radio button) for the trial operation are stored in the slave equipment information 23.

The trial operation screen 900 is displayed on the display unit 7 during a trial operation on the plurality of pieces of slave equipment. An operating content display part 901 is a display area showing information on operating slave equipment (for example, axis). A button 903 is a button for displaying the UI 600 for transferring a startup parameter on the display unit 7.

A trial operation control part 902 includes a plurality of control objects for controlling a trial operation of slave equipment. In this example, three trial operation modes (JOG operation, absolute positioning operation, and relative positioning operation) are selected by tabs. The JOG operation refers to an operation technique of continuously operating the motor driver 4 or the motor 10. The absolute positioning operation refers to an operation technique of moving the motor driver 4 or the motor 10 to one or more coordinate designated by the user. The relative positioning operation refers to an operation technique of moving the motor driver 4 or the motor 10 to one or more coordinate relatively designated by the user. A start button 906 is a button for giving an instruction to start movement to a coordinate set through the trial operation control part 902. A deceleration stop button 907 is a button for decelerating and stopping the axis undergoing the trial operation. A forced stop button 908 is a button for forcibly stopping the axis undergoing the trial operation.

A program generation button 905 is a button for converting operation control of the axis based on control parameters (for example, coordinate, direction, speed, acceleration, deceleration, jerk, and standby time) designated by the trial operation control part 902 into a ladder program (for example, mnemonics or ST).

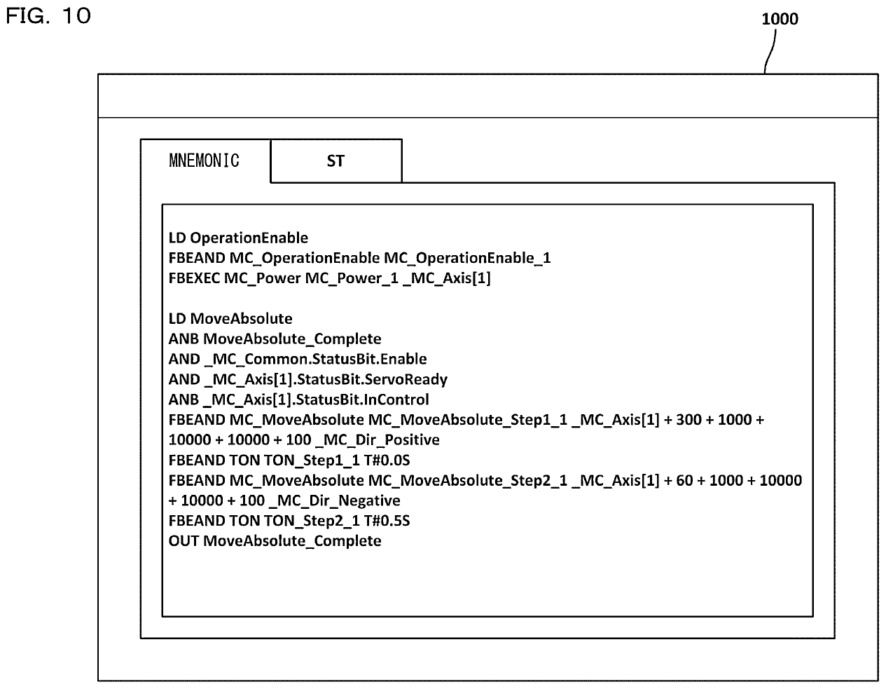

FIG. 10 is a dialog 1000 for displaying a program generated by pressing the program generation button 905. The user may save the program displayed in the dialog 1000 in a copy buffer and paste the program from the copy buffer to an edit screen of the ladder program. That is, the program displayed on the dialog 1000 is handed over from the parameter setting unit 507 to the user program editing unit 501. This makes it easier for the user to edit the program.

### (2) Trial Operation on Plurality of Axes

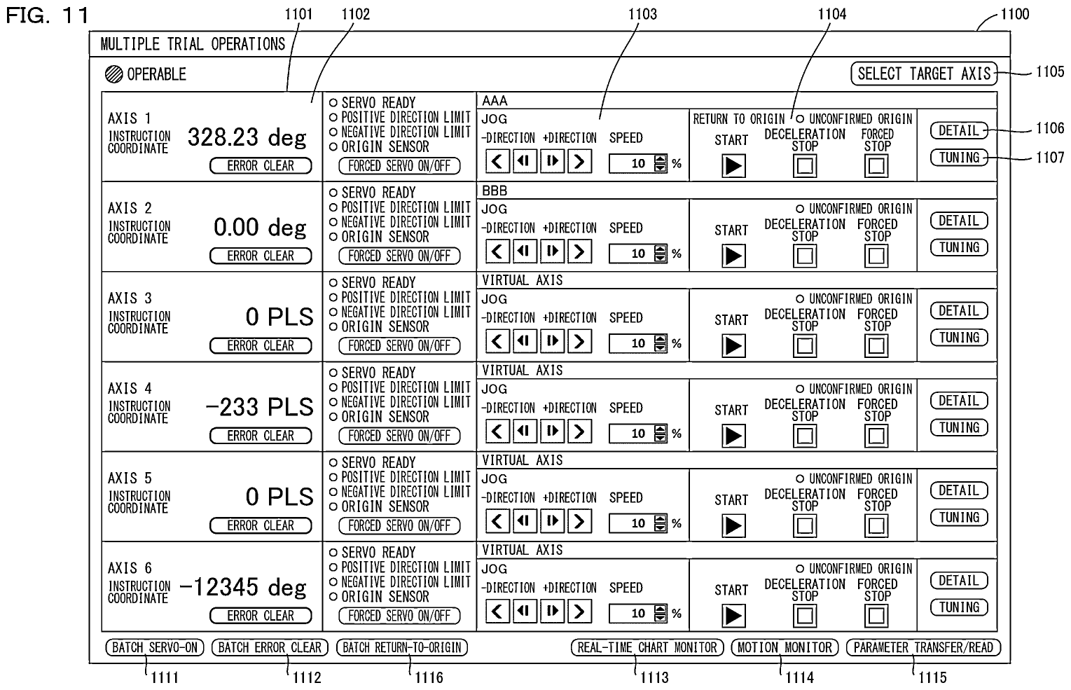

FIG. 11 illustrates a trial operation screen 1100 in a case where a batch trial operation is executed on a plurality of axes. Six trial operation setting parts 1101 are provided for a trial operation on six axes. The trial operation screen 1100 may also be generated so as to have a substantially common appearance regardless of a vendor and a product type (model) of the motor driver 4. However, when a parameter that can be set is different for each of the motor drivers 4, the trial operation screen 1100 corresponding to the parameter that can be set is generated. That is, a type (for example, a current coordinate or an instruction coordinate) of a parameter displayed on the trial operation screen 1100 and a control type (for example, a button, a checkbox, or a radio button) for the trial operation are stored in the slave equipment information 23.

The trial operation setting part 1101 includes a coordinate display area 1102, a JOG operation instruction part 1103, and a return-to-origin instruction part 1104. The coordinate display area 1102 indicates a name of an axis, an instruction coordinate, and the like. The JOG operation instruction part 1103 includes a button for instructing movement by about one step in the negative direction, a button for instructing inching in the negative direction, a button for instructing movement by about one step in the positive direction, a button for instructing inching in the positive direction, speed setting control, and the like. The return-to-origin instruction part 1104 includes a start button for instructing return of the axis to origin, a button for decelerating and stopping the axis, a button for forcibly stopping the axis, and the like. A detail button 1106 is a button for calling a screen displaying detailed information of the axis. A tuning button 1107 is a button for calling the tuning screen 700.

In a lower part of the trial operation screen 1100, a batch servo-on button 1111, a batch error clear button 1112, an RTCM button 1113, a motion monitor button 1114, a parameter transfer/read button 1115, a batch return-to-origin button 1116, and the like may be provided. The batch servo-on button 1111 is a button for collectively transmitting a servo on instruction to the plurality of axes displayed on the trial operation screen 1100. The batch error clear button 1112 is a button for collectively deleting error messages displayed for the plurality of axes displayed on the trial operation screen 1100. The RTCM button 1113 is a button for displaying the RTCM screen 800 for the plurality of axes displayed on the trial operation screen 1100. The motion monitor button 1114 is a button for displaying a motion monitor screen for the plurality of axes displayed on the trial operation screen 1100. The parameter transfer/read button 1115 is a button for displaying the UI 600 for performing parameter transfer and read on the display unit 7. The batch return-to-origin button 1116 is a button for collectively the plurality of axes displayed on the trial operation screen 1100 to return to the origin.

### Flowchart

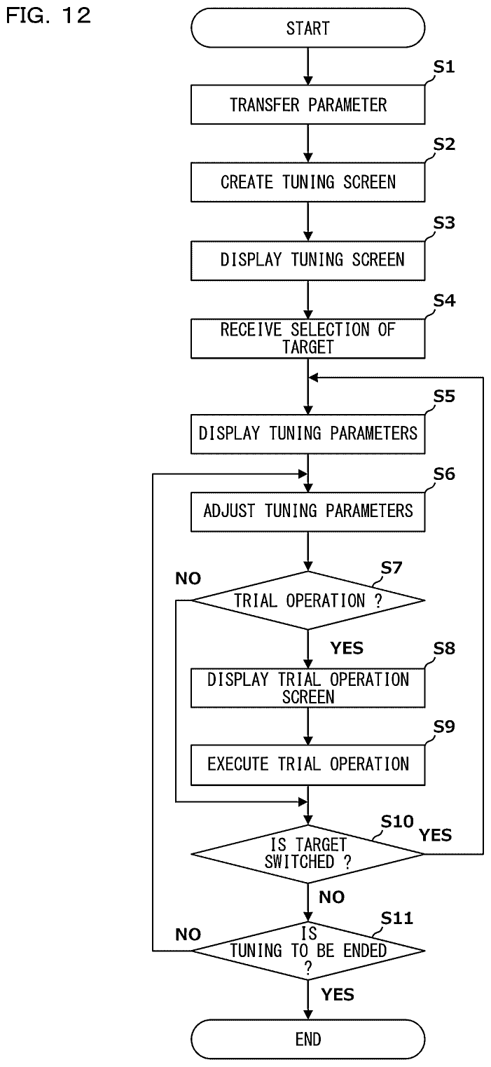

FIG. 12 illustrates a setting method including startup parameter transfer, parameter tuning, and trial operation. The CPU 11 executes the following processing according to the setting support program 21.

In S1, the CPU 11 (the parameter setting unit 507) transfers the startup parameter to the motor driver 4. As described with reference to FIG. 6, the startup parameter is a parameter that needs to be set at a minimum in order to perform tuning or a trial operation of the motor driver 4. The user instructs the CPU 11 to transmit the startup parameter to each of the motor drivers 4 through the common UI 600. The CPU 11 (the parameter setting unit 507 and the write processing unit 512) writes the startup parameter to the target motor driver 4 via the communication part 13 and the basic unit 3.

In S2, the CPU 11 (the parameter setting unit 507, the display processing unit 511, and the tuning screen generation unit 521) creates the tuning screen 700 according to the slave equipment information 23 associated with the motor driver 4 designated by the user. Note that, when there is no motor driver 4 designated by the user at that time, a default screen prepared in advance is created.

In S3, the CPU 11 (the parameter setting unit 507, the display processing unit 511, and the tuning screen generation unit 521) displays the generated tuning screen 700 on the display unit 7.

In S4, the CPU 11 (the parameter setting unit 507 and servo reception unit 524) receives selection of an axis serving as a tuning target. For example, when the axis selection button 723 provided on the tuning screen 700 is pressed, the servo reception unit 524 selectively displays a plurality of axes driven by the motor driver 4 connected to the basic unit 3 (for example, list display), and receives selection of the axis serving as the tuning target. The CPU 11 displays, on the axis selection part 720, the indicator 721 indicating that the axis selected by the user is being selected.

In S5, the CPU 11 (the parameter setting unit 507, display processing unit 511 and the tuning screen generation unit 521) specifies tuning parameters (for example, a tuning mode, machine stiffness setting, and an inertia ratio) according to the slave equipment information 23 associated with the motor driver 4 that drives the axis selected by the user, and displays the specified tuning parameter on the auto-tuning setting part 710 of the tuning screen 700.

In S6, the CPU 11 (the editing unit 523 and the adjustment unit 526) adjusts the tuning parameters according to an instruction of the user. For example, the adjustment unit 526 may adjust the machine stiffness so as to shorten the settling time, for example. The adjustment unit 526 may adjust the tuning parameter according to the tuning mode (for example, adjustment at constant speed, gradual adjustment, or high-speed adjustment) selected by the mode selection part 711. At this time, when the RTCM button 717 is pressed, the CPU 11 generates and displays the RTCM screen 800 on the display unit 7. In the gentle adjustment mode, the response speed of the motor 10 to the instruction decreases so that the settling time becomes long, but mechanical vibration is less likely to occur. In the high-speed adjustment mode, the response speed of the motor 10 to the instruction increases so that the settling time becomes short, but the mechanical vibration is likely to occur. Therefore, it would be sufficient that the user selects the tuning mode according to characteristics required for an apparatus.

In S7, the CPU 11 (the trial operation instruction reception unit 535) determines whether a trial operation instruction for the axis selected by the user has been input. When the trial operation instruction is input, the CPU 11 proceeds from S7 to S8. If the trial operation instruction has not been input, the CPU 11 proceeds from S7 to S10.

In S8, the CPU 11 (the trial operation screen generation unit 531) displays the trial operation screen 900 or 1100 according to the slave equipment information 23 associated with the motor driver 4 that drives the axis selected by the user. When only one axis is selected, the trial operation screen generation unit 531 may generate the trial operation screen 900. When a plurality of axes are selected, the trial operation screen generation unit 531 may generate the trial operation screen 1100.

In S9, the CPU 11 (the reception processing unit 522, write processing unit 512) performs a trial operation for the selected axis according to an instruction input on the trial operation screen 900 or 1100.

In step S10, the CPU 11 (the servo switching unit 525) is optional and determines whether the user has instructed switching of an axis serving as a target of trial operation or tuning. For example, when the axis selection button 723 is pressed and another axis is selected, the CPU 11 determines that the switching of the target is instructed, and proceeds from S10 to S5. Thereafter, the tuning screen 700 for the newly selected axis is displayed (S5), and auto-tuning is executed (S6). When the switching of the target has not been instructed, the CPU 11 proceeds from S10 to S11.

In step S11, the CPU 11 (the reception processing unit 522) determines whether a tuning end instruction has been input by the user. When the end instruction is input, the CPU 11 closes the tuning screen 700 and the trial operation screen 900 or 1100. When the end instruction has not been input, the CPU 11 returns from S11 to S6.

### Others

On the tuning screen 700, a gain (speed gain or position gain), a proportional speed P, an integral control gain I, a phase control gain D, and the like may be displayed in an adjustable manner. Further, in addition to the above, other control parameters (for example, a speed integration time constant, a torque instruction, and an automatic notch filter) and the like may be auto-tuned.

### Technical Ideas Derived From Embodiment

### Viewpoint 1

A basic unit 3 is an example of a programmable logic controller (PLC) that functions as a main part of industrial communication. A motor driver 4 is an example of a motor driving apparatus that functions as a peripheral of the industrial communication and drives a motor based on motor control data transmitted from the main part by the industrial communication. A PC 2 is an example of a setting support apparatus that supports setting of a PLC system 1. A CPU 11 (reception processing unit 522) may operate as a selection unit that selects any motor driver 4 from among a plurality of the motor drivers 4 specified by pieces of vendor specifying information and pieces of product specifying information, respectively, as the peripheral connected to the basic unit 3 functioning as the main part. A storage apparatus 12 is an example of a storage unit that stores setting information (for example, slave equipment information 23) related to motor control of each of the plurality of motor drivers 4, the setting information being associated with a combination of the vendor specifying information and the product specifying information. The CPU 11 and a display processing unit 511 function as a screen generation unit that reads the setting information corresponding to the combination of the vendor specifying information and the product specifying information associated with the selected motor driver 4 from the storage apparatus 12, and generates an interface screen for a trial operation or tuning of the motor driver 4 based on the setting information. The CPU 11 and a write processing unit 512 function as a transmission unit that transmits an instruction received through the generated interface screen (for example, tuning screen 700, trial operation screen 900 or 1100) to the motor driver via the basic unit 3 and the industrial communication.

In the related art, software prepared for each manufacturer or each of the motor drivers 4 needs to be installed in the PC 2, and the PC 2 needs to be directly connected to the motor drivers 4 to perform tuning or a trial operation. Thus, as the number of models of the motor drivers 4 increase, the number of pieces of dedicated software also increases, and a user needs to be proficient in a large number of pieces of software. In order to perform tuning or a trial operation on the plurality of motor drivers 4 at the same time, the user needs to input instructions from a plurality of different UIs respectively prepared for the motor drivers 4, which is complicated. Furthermore, the user needs to replace a communication cable each time the driver serving as a target of tuning or a trial operation is switched. Therefore, in an environment in which various models having different vendors exist together, there is a large burden on the user in tuning and a trial operation. According to the present embodiment, since a common interface screen is prepared, the burden on the user regarding a trial operation or tuning when a plurality of motor drivers whose manufacturers are different from each other are connected to the PLC is mitigated.

### Viewpoint 2

The CPU 11 and a servo reception unit 524 may receive selection of one motor driver 4 or an axis thereof to be tuned through the interface screen from among the plurality of motor drivers 4 connected to the basic unit 3. The CPU 11 (tuning screen generation unit 521) may read, from the storage apparatus 12, the setting information (for example, slave equipment information 23) corresponding to the combination of the vendor specifying information and the product specifying information associated with one motor driver 4 whose selection has been received, and generate an interface screen (for example, tuning screen 700) for tuning the one motor driver 4 based on the setting information.

### Viewpoint 3

The interface screen may include a tuning screen 700 for tuning a control parameter (for example, machine stiffness, inertia ratio) of the motor driver 4. The tuning screen 700 may receive tuning of the control parameter based on slave equipment information 23 corresponding to a combination of the vendor specifying information and the product specifying information of the motor driver 4.

### Viewpoint 4

The tuning screen 700 may include a switching unit (for example, axis selection button 723) that receives an instruction to switch the motor driver 4 or an axis thereof serving as a tuning target among the plurality of motor drivers 4, and an adjustment unit (for example, machine stiffness setting part 713, inertia ratio setting unit 715) of one or more control parameters for the motor driver 4 or the axis serving as the tuning target instructed by the switching unit.

### Viewpoint 5

The servo reception unit 524 may receive selection of one motor driver 4 or an axis thereof to be subjected to a trial operation through the interface screen from among the plurality of motor drivers 4 connected to the basic unit 3 or axes thereof. A trial operation screen generation unit 531 of the display processing unit 511 may be configured to read, from the storage apparatus 12, the setting information (slave equipment information 23) corresponding to the combination of the vendor specifying information and the product specifying information associated with the one motor driver 4 or the axis of which the selection is received, and to generate an interface screen (trial operation screen 900 or 1100) for a trial operation of the one motor driver 4 or the axis based on the setting information.

### Viewpoint 6

The interface screen may include a trial operation screen 900 or 1100 that receives an instruction to perform a trial operation of the motor driver 4. The trial operation screen 900 or 1100 may receive an instruction regarding operation content (for example, JOG operation, inching operation, absolute positioning, assumed positioning) based on the setting information (slave equipment information 23) corresponding to the combination of the vendor specifying information and the product specifying information of the motor driver 4.

### Viewpoint 7

The trial operation screen 1100 may include a plurality of instruction parts (for example, JOG operation instruction part 1103, return-to-origin instruction part 1104) provided for the plurality of motor drivers 4 or the axes on a one-to-one basis in order to perform trial operations of the plurality of motor drivers 4 or the axes in parallel. This makes it possible to individually input trial operation instructions to a plurality of axes while simultaneously displaying states of the plurality of axes.

### Viewpoint 8

The CPU 11 and a converter 536 function as a converter that converts operation content designated on the trial operation screen 900 into a program (for example, mnemonics) for causing the motor driver 4 or an axis thereof to execute. As a result, the user can easily create the program.

### Viewpoint 9

The converter 536 may convert the operation content into a program described in mnemonics and copy the program to a clipboard (copy buffer). As a result, the program can be pasted on a program edit screen.

### Viewpoint 10

As illustrated in FIG. 11, the trial operation may include a JOG operation or return to origin.

### Viewpoint 11

According to the present embodiment, there is also provided the PLC system 1 including the setting support apparatus (PC 2) described in the Viewpoints 1 to 10. Note that Viewpoints 1 to 10 can be arbitrarily combined as long as there is no technical inconsistency.

### Viewpoint 12

A setting support program 21 is an example of a computer program that supports setting of the PLC system 1. Further, the setting support program 21 is a program for causing a computer (for example, PC 2) to function as:
a selection unit that selects any motor driving apparatus from among a plurality of motor driving apparatuses specified by pieces of vendor specifying information and pieces of product specifying information, respectively, as a peripheral to be connected to a programmable logic controller functioning as a main part;
a storage unit that stores setting information related to motor control of each of the plurality of motor driving apparatuses, the setting information being associated with a combination of the vendor specifying information and the product specifying information;
a screen generation unit that reads, from the storage unit, the setting information corresponding to a combination of the vendor specifying information and the product specifying information associated with the motor driving apparatus selected by the selection unit, and generates an interface screen for a trial operation or tuning of the motor driving apparatus based on the setting information; and
a transmission unit that transmits an instruction received through the interface screen generated by the screen generation unit to the motor driving apparatus via the programmable logic controller and industrial communication.

### Other Modification 1

In the above-described embodiment, an example (FIG. 10) is illustrated in which a program in a mnemonic language is displayed on the dialog 1000 when the program generation button 905 illustrated in FIG. 9 is pressed. The invention is not limited thereto. For example, a program in an ST language may be generated, and the program in the ST language may be displayed on the dialog 1000.

Further, the generated program may reflect control parameters (for example, coordinate, direction, speed, acceleration, deceleration, jerk, and standby time) set through the trial operation control part 902. That is, content of the generated program may be changed between a case where the program generation button 905 is pressed before the setting of the control parameters is changed and a case where the program generation button 905 is pressed after the setting of the control parameter is changed. In short, the program may be generated and displayed according to the control parameters set through the trial operation control part 902.

Note that the program generated in the mnemonic language may be converted from the mnemonic language into a ladder diagram (ladder block) using a function of ladder editing software, and the ladder diagram (ladder block) after the conversion may be inserted (pasted) into the ladder program. On the other hand, the program generated in the ST language may be directly inserted (pasted) into the ladder program.

### Other Modification 2

In the above-described embodiment, FIG. 7 illustrates that one axis set through the auto-tuning setting part 710 is selected by the axis selection button 723. In general, when a plurality of processes are controlled by one PLC, the number of axes tends to increase. For example, when tuning is executed on a process-by-process basis, only an axis related to the process may be selected and displayed on the tuning screen. As a result, the user can easily perform necessary tuning. Note that a separate dialog may be displayed when the axis selection button 723 is pressed, and an axis to be displayed on the tuning screen 700 may be selected in accordance with a user operation.

The invention is not limited to the above embodiment, and various modifications and changes can be made within a scope of a gist of the invention.

What is claimed is:

1. A setting support apparatus that supports setting of a programmable logic controller system including
a programmable logic controller that functions as a main part of industrial communication and
a motor driving apparatus that functions as a peripheral of the industrial communication and drives a motor based on motor control data transmitted from the main part by the industrial communication, the setting support apparatus comprising:
a selection unit configured to select any motor driving apparatus from among a plurality of the motor driving apparatuses specified by pieces of vendor specifying information and pieces of product specifying information, respectively, as the peripheral to be connected to the programmable logic controller functioning as the main part;
a storage unit configured to store setting information related to motor control of each of the plurality of motor driving apparatuses, the setting information being associated with a combination of the vendor specifying information and the product specifying information;
a screen generation unit configured to read, from the storage unit, the setting information corresponding to a combination of the vendor specifying information and the product specifying information associated with the motor driving apparatus selected by the selection unit, and to generate an interface screen for a trial operation or tuning of the motor driving apparatus based on the setting information; and
a transmission unit configured to transmit an instruction received through the interface screen generated by the screen generation unit to the motor driving apparatus via the programmable logic controller and the industrial communication.

2. The setting support apparatus according to claim 1, further comprising
a reception unit configured to receive selection of one motor driving apparatus to be tuned through the interface screen from among the plurality of motor driving apparatuses connected to the programmable logic controller, wherein
the screen generation unit is configured to read, from the storage unit, the setting information corresponding to a combination of the vendor specifying information and the product specifying information associated with the one motor driving apparatus whose selection has been received by the reception unit, and to generate the interface screen for tuning the one motor driving apparatus based on the setting information.

3. The setting support apparatus according to claim 2, wherein
the interface screen includes a tuning screen for tuning a control parameter of the one motor driving apparatus, and
the tuning screen receives tuning of the control parameter based on the setting information corresponding to the combination of the vendor specifying information and the product specifying information of the one motor driving apparatus.

4. The setting support apparatus according to claim 3, wherein
the tuning screen includes:
a switching unit configured to receive an instruction to switch a motor driving apparatus serving as a tuning target among the plurality of motor driving apparatuses; and
an adjustment unit of one or more control parameters for the motor driving apparatus serving as the tuning target instructed by the switching unit.

5. The setting support apparatus according to claim 1, further comprising
a reception unit configured to receive selection of one motor driving apparatus to be subjected to a trial operation through the interface screen from among the plurality of motor driving apparatuses connected to the programmable logic controller, wherein
the screen generation unit is configured to read, from the storage unit, the setting information corresponding to a combination of the vendor specifying information and the product specifying information associated with the one motor driving apparatus whose selection has been received by the reception unit, and to generate the interface screen for the trial operation of the one motor driving apparatus based on the setting information.

6. The setting support apparatus according to claim 5, wherein
the interface screen includes a trial operation screen that receives an instruction to perform the trial operation of the one motor driving apparatus, and
the trial operation screen receives an instruction regarding operation content based on the setting information corresponding to the combination of the vendor specifying information and the product specifying information of the one motor driving apparatus.

7. The setting support apparatus according to claim 6, wherein the trial operation screen includes a plurality of instruction parts provided for the plurality of motor driving apparatuses on a one-to-one basis to perform trial operations of the plurality of motor driving apparatuses in parallel.

8. The setting support apparatus according to claim 6, further comprising a converter configured to convert the operation content designated on the trial operation screen into a program for causing the one motor driving apparatus to execute.

9. The setting support apparatus according to claim 8, wherein the converter converts the operation content into the program described in mnemonics, and copies the program to a clipboard.

10. The setting support apparatus according to claim 5, wherein the trial operation includes a JOG operation or return to origin.

11. A programmable logic controller system comprising:
a programmable logic controller that functions as a main part of industrial communication;
a motor driving apparatus configured to function as a peripheral of the industrial communication and drives a motor based on motor control data transmitted from the main part by the industrial communication; and
a setting support apparatus, wherein
the setting support apparatus includes:
a selection unit configured to select any motor driving apparatus from among a plurality of the motor driving apparatuses specified by pieces of vendor specifying information and pieces of product specifying information, respectively, as the peripheral to be connected to the programmable logic controller functioning as the main part;
a storage unit configured to store setting information related to motor control of each of the plurality of motor driving apparatuses, the setting information being associated with a combination of the vendor specifying information and the product specifying information;
a screen generation unit configured to read, from the storage unit, the setting information corresponding to a combination of the vendor specifying information and the product specifying information associated with the motor driving apparatus selected by the selection unit, and to generate an interface screen for a trial operation or tuning of the motor driving apparatus based on the setting information; and
a transmission unit configured to transmit an instruction received through the interface screen generated by the screen generation unit to the motor driving apparatus via the programmable logic controller and the industrial communication.

12. A computer program products comprising a non-transitory computer-readable storage medium having a computer program for supporting setting of a programmable logic controller system including
a programmable logic controller that functions as a main part of industrial communication and
a motor driving apparatus that functions as a peripheral of the industrial communication and drives a motor based on motor control data transmitted from the main part by the industrial communication, the computer program causing a computer to function as:
a selection unit configured to select any motor driving apparatus from among a plurality of the motor driving apparatuses specified by pieces of vendor specifying information and pieces of product specifying information, respectively, as the peripheral to be connected to the programmable logic controller functioning as the main part;
a storage unit configured to store setting information related to motor control of each of the plurality of motor driving apparatuses, the setting information being associated with a combination of the vendor specifying information and the product specifying information;
a screen generation unit configured to read, from the storage unit, the setting information corresponding to a combination of the vendor specifying information and the product specifying information associated with the motor driving apparatus selected by the selection unit, and to generate an interface screen for a trial operation or tuning of the motor driving apparatus based on the setting information; and
a transmission unit configured to transmit an instruction received through the interface screen generated by the screen generation unit to the motor driving apparatus via the programmable logic controller and the industrial communication.
